(19) United States
(12) Patent Application Publication
(10) Pub. No.: US 2025/0219756 A1
(43) Pub. Date: Jul. 3, 2025

(54) FIBER SHUFFLE BOX, DATA PROCESSING METHOD AND COMPUTER STORAGE MEDIUM

(71) Applicant: CLOUD INTELLIGENCE ASSETS HOLDING (SINGAPORE) PRIVATE LIMITED, Singapore (SG)

(72) Inventors: Huan ZHANG, Hangzhou (CN); Liang DOU, Beijing (CN); Sai CHEN, Hangzhou (CN); Chongjin XIE, Hangzhou (CN)

(21) Appl. No.: 18/851,027

(22) PCT Filed: Mar. 24, 2023
(86) PCT No.: PCT/CN2023/083877

§ 371 Date: Sep. 25, 2024

(30) Foreign Application Priority Data
Mar. 25, 2022 (CN) 202210300284.0

(51) Int. Cl. H04J 14/02; G02B 6/44

(52) U.S. Cl. CPC H04J 14/0201; G02B 6/4446

(57) ABSTRACT

Embodiments of the present disclosure provide a fiber shuffle box, a data processing method and a computer storage medium. The fiber shuffle box includes: a shuffle box main body and a splitter, where the splitter is built in the shuffle box main body, the shuffle box main body is provided with a first fiber connection splice for connecting with a line direction unit and a second fiber connection splice for connecting with a local add-drop unit, the splitter is connected between the first fiber connection splice and the second fiber connection splice, and the number of wire cores of the second fiber connection splice is smaller than the number of wire cores of the first fiber connection splice. The fiber shuffle box has higher compatibility.

### CROSS-REFERENCE TO RELATED APPLICATIONS

This application is a National Stage of International Application No. PCT/CN2023/083877, filed on Mar. 24, 2023, which claims priority to Chinese Patent Application No. 202210300284.0, filed to China National Intellectual Property Administration on Mar. 25, 2022 and entitled “FIBER SHUFFLE BOX, DATA PROCESSING METHOD AND COMPUTER STORAGE MEDIUM”, both of which are hereby incorporated by reference in their entireties.

### TECHNICAL FIELD

Embodiments of the present application relate to the field of computer technologies and, in particular, to a fiber shuffle box, a data processing method and a computer storage medium.

### BACKGROUND

In a directionless reconfigurable optical add-drop multiplexer (D-ROADM), it can be realized that after a wavelength channel in one outbound direction is interrupted, a wavelength service can be remotely scheduled to another direction for outbound, so that a function can be restored more quickly. The reconfigurable optical add-drop multiplexer includes a local add-drop unit, a fiber shuffle box and a line direction unit. The local add-drop unit needs to be configured with a 1: n splitter to connect the wavelength to all directions. However, the existing reconfigurable optical add-drop multiplexer cannot realize the compatibility between devices from different manufacturers, which makes it difficult to be heterogeneous.

### SUMMARY

In view of this, embodiments of the present application provide a fiber shuffle box solution to at least partially solve the above problems.

According to a first aspect of the embodiments of the present application, a fiber shuffle box is provided, including: a shuffle box main body and a splitter, where the splitter is built in the shuffle box main body, the shuffle box main body is provided with a first fiber connection splice for connecting with a line direction unit and a second fiber connection splice for connecting with a local add-drop unit, the splitter is connected between the first fiber connection splice and the second fiber connection splice, and the number of wire cores of the second fiber connection splice is smaller than the number of wire cores of the first fiber connection splice.

According to a second aspect of the embodiments of the present application, a reconfigurable optical add-drop multiplexer is provided, including: a line direction unit, a fiber shuffle box and a local add-drop unit, where the line direction unit is connected with a first fiber connection splice of the fiber shuffle box through a multi-fiber push on (MPO) connection line, the local add-drop unit is connected with a second fiber connection splice of the fiber shuffle box through a lucent connector (LC) connection line, a splitter is built in the fiber shuffle box, and the splitter is connected with the second fiber connection splice in one-to-one correspondence.

According to a third aspect of the embodiments of the present application, a data processing method is provided, the method is applied to the above reconfigurable optical add-drop multiplexer, and the method includes: performing multiplexing on optical waves to be sent by using a multiplexer to obtain an optical wave signal; performing multiplexing loss compensation processing on the optical wave signal by using an uplink power amplify to obtain a compensated optical wave signal; and sending the compensated optical wave signal to a splitter of a fiber shuffle box through an LC connection line, so that the splitter divides the compensated optical wave signal into N uplink signals and sends the N uplink signals to corresponding line direction units in one-to-one correspondence, where a value of N is matched with the number of the line direction units.

According to a fourth aspect of the embodiments of the present application, a data processing method is provided, the method is applied to the above reconfigurable optical add-drop multiplexer, and the method includes: acquiring, from a plurality of line direction units, partial optical wave signals corresponding to wavelengths of wavelength selection switches of the line direction units; performing, by using a splitter, multiplexing processing on the partial optical wave signals acquired from the plurality of line direction units to form a multiplexed signal; and sending the multiplexed signal to the local add-drop unit through an LC connection line.

According to a fifth aspect of the embodiments of the present application, a computer storage medium is provided, having a computer program stored thereon, where when the program is executed by a processor, the aforementioned method is implemented.

According to a sixth aspect of the embodiments of the present application, a computer program product is provided, including computer instructions, where the computer instructions instruct a computing device to perform operations corresponding to the above method.

According to the embodiments of the present application, the structure of the shuffle box main body of the fiber shuffle box and contained devices may be the same as or similar to that of the existing fiber shuffle box, which is not limited. The shuffle box main body is further provided with a splitter to realize processing to optical wave signals. Since the splitter is already built in the fiber shuffle box, a splitter in the local add-drop unit could be omitted, which makes the structure of the local add-drop unit simpler, so as to reduce the design complexity. In addition, because the splitter and the local add-drop unit can be connected by using a standard and better compatible second fiber connection splice (such as an LC splice), the reliability and compatibility are improved, and when constructing a reconfigurable optical add-drop multiplexer, the line direction unit and the local add-drop unit with different structures can be used, thus realizing heterogeneity and reducing the cost of heterogeneity.

### BRIEF DESCRIPTION OF DRAWINGS

In order to more clearly illustrate the technical solutions of the embodiments of the present disclosure or the prior art, the drawings needed to be used in the description of the embodiments or the prior art will be briefly introduced below. Obviously, the drawings in the following description are some embodiments of the present application, and for those skilled in the art, other drawings can be obtained according to these drawings.

FIG. 1A is a schematic diagram of an existing reconfigurable optical add-drop multiplexer as a node in an optical network.

FIG. 1B is schematic architecture diagram of a reconfigurable optical add-drop multiplexer according to the present application.

FIG. 1C is another schematic architecture diagram of a reconfigurable optical add-drop multiplexer according to the present application.

FIG. 2 is a schematic diagram of a fiber shuffle box according to Embodiment I of the present application.

FIG. 3A is a schematic diagram of a connection relationship of a reconfigurable optical add-drop multiplexing system according to Embodiment II of the present application.

FIG. 3B is a schematic architecture diagram of a reconfigurable optical add-drop multiplexer according to Embodiment II of the present application.

FIG. 3C is a schematic wiring diagram of a fiber shuffle box according to Embodiment II of the present application.

FIG. 4 is a schematic flowchart of steps of a data processing method according to Embodiment III of the present application.

FIG. 5 is a schematic flowchart of steps of a data processing method according to Embodiment IV of the present application.

FIG. 6 is a structural block diagram of a data processing apparatus according to Embodiment V of the present application.

FIG. 7 is a structural block diagram of a data processing apparatus according to Embodiment VI of the present application.

FIG. 8 is a schematic structural diagram of an electronic device according to Embodiment VII of the present application.

### DESCRIPTION OF EMBODIMENTS

In order to make those skilled in the art better understand technical solutions in the embodiments of the present application, the technical solutions in the embodiments of the present application will be clearly and comprehensively described with reference to the accompanying drawings in the embodiments of the present application. Obviously, the described embodiments are only a part of embodiments of the present application, rather than all embodiments. Based on the embodiments in the present application, all other embodiments obtained by one of ordinary skill in the art should belong to the protection scope of the embodiments of the present application.

The specific implementation of the embodiments of the present application will be further explained with reference to the accompanying drawings of the embodiments of the present application.

### Embodiment I

In this embodiment, a new Fiber Shuffle Box is provided. By providing a splitter in the fiber shuffle box, a heterogeneous ROADM (Reconfigurable Optical Add-Drop Multiplexer) can be constructed in relatively low cost through the new fiber shuffle box, and it can be ensured that the compatibility and reliability of ROADM are better.

In order to more clearly explain the beneficial effects of the new fiber shuffle box, before explaining the fiber shuffle box of the embodiment of the present application, an existing fiber shuffle box and an architecture of ROADM are briefly described as follows.

In the existing optical network, the nodes usually have multiple line directions, and different directions of the nodes constitute multiple end-to-end routes in the optical network. Therefore, in order to improve the reliability of wavelength channels in the optical network and enhance the flexibility of the whole optical network, it is required that the wavelength channels can be flexibly scheduled in the nodes.

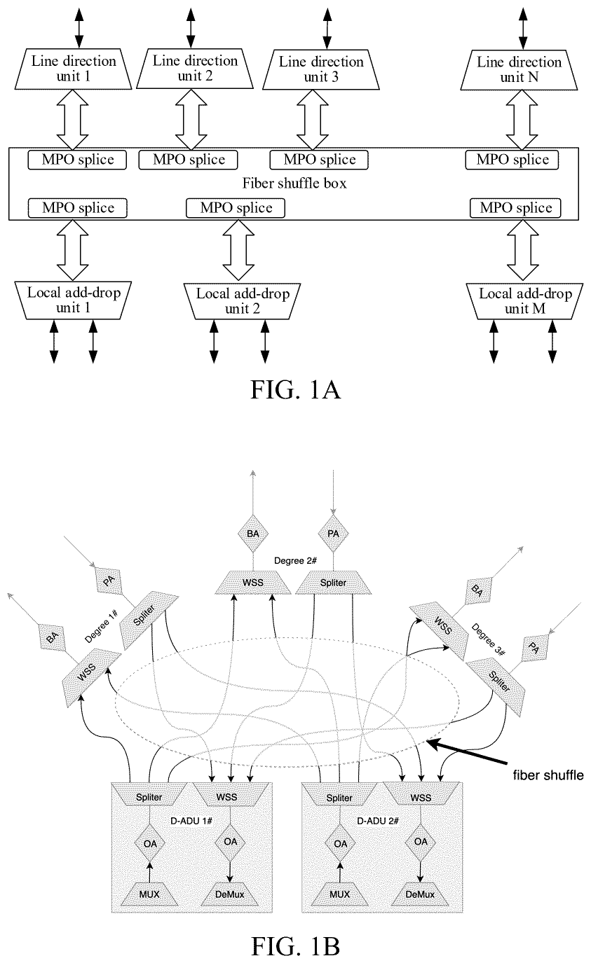

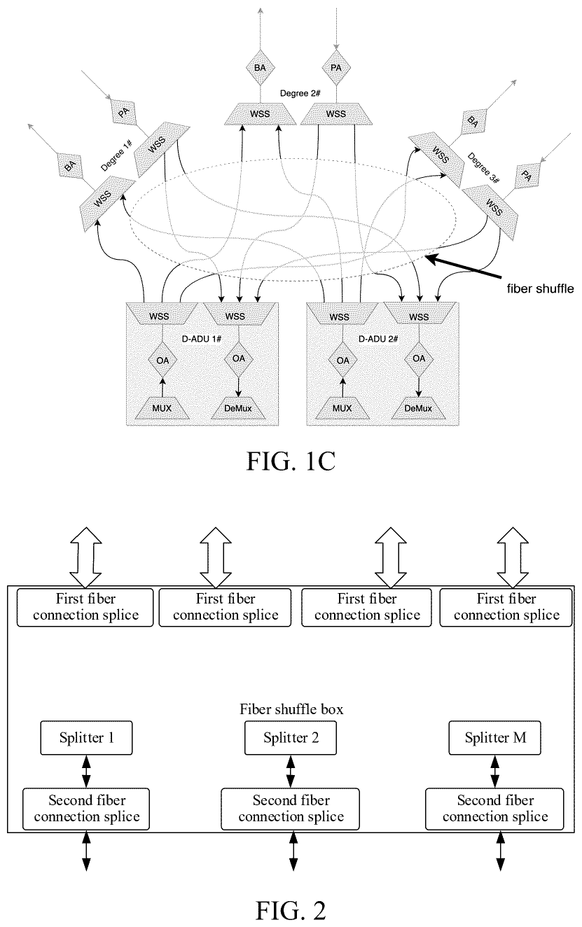

As shown in FIG. 1A, it shows a schematic diagram of a node in an optical network. The node may be a ROADM system, and the node usually includes a fiber shuffle box, a local add-drop unit (ADU) and a line direction unit, so as to realize flexible wavelength scheduling between different directions. Such ROADM system that the wavelength could be flexibly scheduled to different directions can be referred to as a D-ROADM (directionless ROADM) system, and such D-ROADM system further improves the flexibility of the optical network.

In such D-ROADM system, after a wavelength channel in one outbound direction is interrupted, a wavelength service can be remotely scheduled to another direction for outbound, so that a function can be restored more quickly. In order to realize this function, the local add-drop unit needs to be configured with a 1: n splitter to connect the wavelength to all directions. Therefore, as shown in FIG. 1A, the existing fiber shuffle box includes a plurality of dimension interfaces and a plurality of local interfaces, the number of the dimension interfaces corresponds to directions, each dimension interface is connected to one line direction unit, the local interfaces correspond to local add-drop units, and one local interface is connected to one local add-drop unit. Both the dimension interfaces and the local interfaces are MPO splices, so that the line direction units and the local add-drop units are connected to the fiber shuffle box, and then fibers from the interfaces are interconnected separately by the fiber shuffle box.

Based on whether architectures of the line direction unit and the local add-drop unit are the same, the existing D-RAODM system could be divided into a BS structure and a RS structure.

FIG. 1B shows a D-ROADM system with the BS structure. The fiber shuffle box is connected with the line direction units and the local add-drop units separately through the MPO splices. The line direction unit includes two wavelength selective switches (WSS) and power amplifiers BA and PA. The local add-drop unit includes a 1: n splitter, a wavelength selective switch (WSS), a power amplifier OA and a multiplexer (MUX or DeMux).

In signal sending, a dense wavelength division multiplexing (DWDM) signal multiplexed by the multiplexer MUX is split into multiple parts by the splitter and sent to the fiber shuffle box, the fiber shuffle box distributes the multiple parts to the line direction units corresponding to the dimensions, and a wavelength selective switch WSS in the line direction unit of each dimension selects a signal with correct wavelength to send.

In signal receiving, a wavelength selective switch WSS of the line direction unit of each dimension selects a signal with corresponding wavelength from optical multiplex section (OMS) signals broadcast in all directions, the signal with the wavelength is sent to the local add-drop unit through the fiber shuffle box, and a wavelength selective switch WSS of the local add-drop unit selects the appropriate wavelength, which is multiplexed by the multiplexer DeMux and then sent to the local.

FIG. 1C shows a D-ROADM system with the RS structure. The fiber shuffle box is connected with the line direction units and the local add-drop units separately through the MPO splices. The line direction unit includes two wavelength selective switches (WSS) and power amplifiers BA and PA. The local add-drop unit includes two wavelength selective switches (WSS), a power amplifier OA and a multiplexer (MUX or DeMux).

In such structure, the local add-drop unit is similar to the line direction unit, and each of them is composed of two wavelength selective switches. In signal sending and receiving, the selected wavelength is routed to a specified direction through a wavelength selective switch, and then this wavelength is selected by the WSS at the direction port.

Whether it is the BS structure or the RS structure, MPO splices are needed in such ROADM system for connecting the line direction unit and the local add-drop unit with the fiber shuffle box. Since the connection mode and the transmission protocol of the MPO splice are a private mode and a private protocol, the line direction unit and the local add-drop unit of the ROADM system need to be built by using devices of the same manufacturer, which cannot be heterogeneous, and the MPO splice has poor reliability and insufficient compatibility, resulting in higher cost.

In order to solve this problem, as shown in FIG. 2, an embodiment of the present application provides a fiber shuffle box, which includes: a shuffle box main body and a splitter, where the splitter is built in the shuffle box main body, the shuffle box main body is provided with a first fiber connection splice for connecting with a line direction unit and a second fiber connection splice for connecting with a local add-drop unit, the splitter is connected between the first fiber connection splice and the second fiber connection splice, and the number of wire cores of the second fiber connection splice is smaller than the number of wire cores of the first fiber connection splice.

The structure of the shuffle box main body of the fiber shuffle box and contained devices may be the same as or similar to the existing fiber shuffle box, which is not limited. The shuffle box main body is further provided with a splitter to realize processing to optical wave signals. Since the splitter is already built in the fiber shuffle box, a splitter in the local add-drop unit could be omitted, which makes the structure of the local add-drop unit simpler, so as to reduce the design complexity. In addition, because the splitter and the local add-drop units can be connected by using a second fiber connection splice (such as an LC splice) with standard and fewer wire cores, the number of wire cores of the second fiber connection splice is smaller than the number of wire cores of the first fiber connection splice, compared with the number of wire cores of the first fiber connection splice being relatively large and the connection modes being in many different ways, the number of wire cores of the second fiber connection splice is relatively small and the connection modes are fixed. Therefore, the compatibility of the second fiber connection splice is better than the compatibility of the first fiber connection splice, which improves the reliability and compatibility of the fiber shuffle box that connects with the local add-drop unit by using the second fiber connection splice, and when constructing a reconfigurable optical add-drop multiplexer, the line direction unit and the local add-drop unit with different structures can be used, thus realizing heterogeneity and reducing the cost of heterogeneity.

In an implementation, the first fiber connection splice uses a private transmission protocol, the second fiber connection splice uses a standard transmission protocol, and the second fiber connection splice is connected with the splitter in one-to-one correspondence. For example, the first fiber connection splice may be an MPO splice and the second fiber connection splice may be an LC splice.

The MPO splice is a multi-wire core splice, the number of its wire cores is at least three, and its transmission protocol is a private transmission protocol, which cause that when connecting the local add-drop unit and the line direction unit by using the MPO splice, it is required to use the local add-drop unit and the line direction unit of the same manufacturer to ensure normal communication. However, in the case of built-in splitter, since a standard LC splice can be used to connect the splitter and the local add-drop unit, the problem is overcome.

### Embodiment II

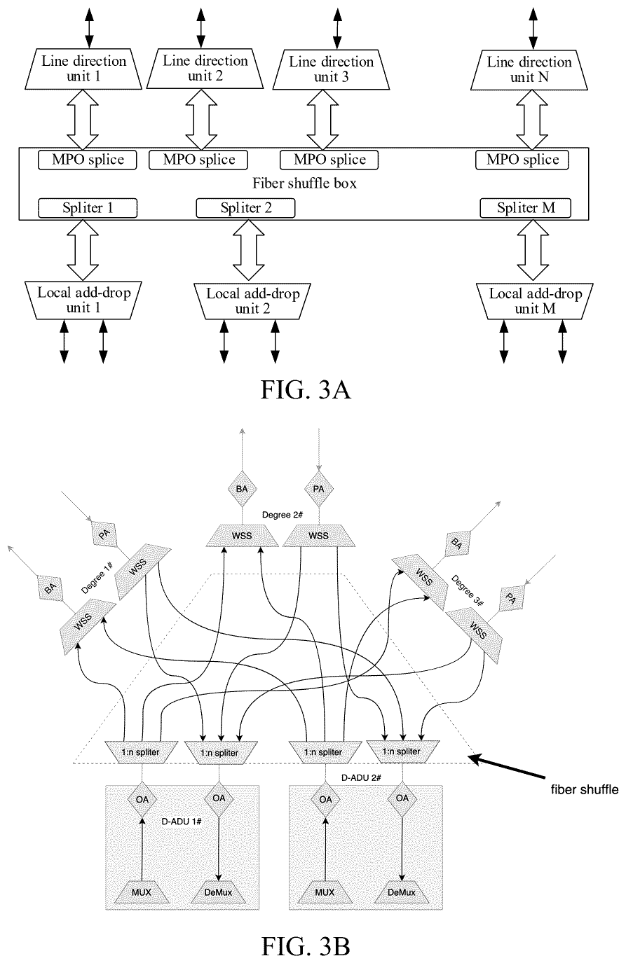

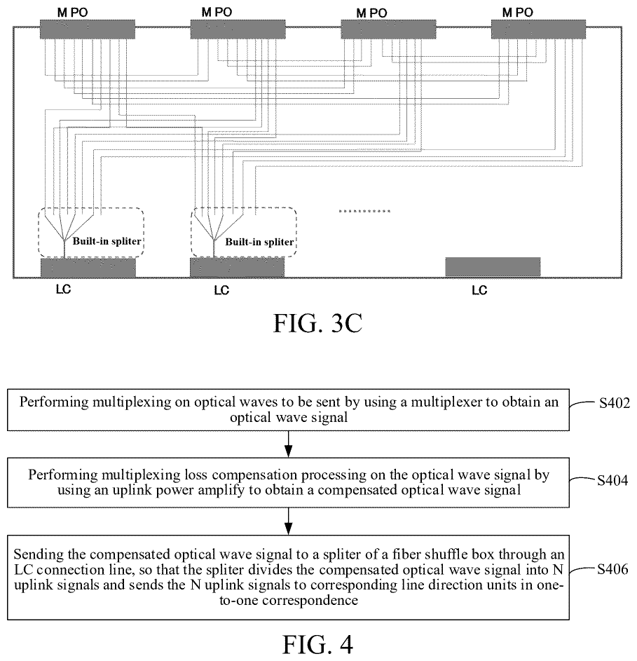

Referring to FIG. 3A, a schematic structural diagram of a reconfigurable optical add-drop multiplexer according to Embodiment II of the present application is shown.

The reconfigurable optical add-drop multiplexer includes a line direction unit, a fiber shuffle box and a local add-drop unit, where the line direction unit is connected with a first fiber connection splice of the fiber shuffle box through an MPO connection line, the local add-drop unit is connected with a second fiber connection splice of the fiber shuffle box through an LC connection line, a splitter is built in the fiber shuffle box, and the splitter is connected with the second fiber connection splice in one-to-one correspondence.

The second fiber connection splice on the fiber shuffle box of the reconfigurable optical add-drop multiplexer could be an LC splice, and the LC splice can be used between the local add-drop unit and the second fiber connection splice of the fiber shuffle box. Because this kind of simple and standard LC connection line is used, there is no adaptation problem of the number of wire cores and the line sequence in connection through the MPO connection lines.

In this embodiment, the line direction unit and the local add-drop unit are heterogeneous, so that cross-manufacturer heterogeneity can be realized between the local add-drop unit and the line direction unit, thereby reducing the cost.

In an implementation, as shown in FIG. 3B, the line direction unit includes an outgoing power amplifier, an incoming power amplifier, an outgoing wavelength selective switch and an incoming wavelength selective switch, where the outgoing power amplifier is connected with the outgoing wavelength selective switch, and the incoming power amplifier is connected with the incoming wavelength selective switch. In this way, stable and reliable signal transmission can be ensured.

In an implementation, the local add-drop unit includes an uplink power amplifier, a downlink power amplifier, an uplink multiplexer and a downlink multiplexer, where the uplink power amplifier is connected with the uplink multiplexer, and the downlink power amplifier is connected with the downlink multiplexer. The cost structure of such local add-drop unit is simpler and the cost is lower. The schematic wiring diagram is shown in FIG. 3C.

The local add-drop unit and the fiber shuffle box in this heterogeneous reconfigurable optical add-drop multiplexer are connected by using a standard LC splice, which makes the reliability higher and can realize heterogeneity among different manufacturers, thus reducing the maintenance cost.

### Embodiment III

Referring to FIG. 4, a schematic flowchart of steps of a data processing method of Embodiment III of the present application is shown.

The data processing method is applied to the reconfigurable optical add-drop multiplexer, and the method includes the following steps.

Step S402: performing multiplexing on optical waves to be sent by using a multiplexer to obtain an optical wave signal.

When the local add-drop unit transmits a signal to outside, the multiplexer MUX performs multiplexing on optical waves to form the optical wave signal.

Step S404: performing multiplexing loss compensation processing on the optical wave signal by using an uplink power amplify to obtain a compensated optical wave signal.

The uplink power amplify OA amplifies the optical wave signal to compensate the insertion loss of the multiplexed part to form the compensated optical wave signal.

Step S406: sending the compensated optical wave signal to a splitter of a fiber shuffle box through an LC connection line, so that the splitter divides the compensated optical wave signal into N uplink signals and sends the N uplink signals to corresponding line direction units in one-to-one correspondence, where a value of N is matched with the number of the line direction units.

The compensated optical wave signal is transmitted to the splitter of the fiber shuffle box through the LC connection line and the LC splice. The splitter divides the compensated optical wave signal into N parts and sends to the connected MPO splices, and sends to the line direction units through the MPO splice and the MPO connection line.

A wavelength selective switch WSS on the line direction unit selects the corresponding wavelength and sends it to the transmission line.

Through the above-mentioned way, the wavelength can be added to any direction.

### Embodiment IV

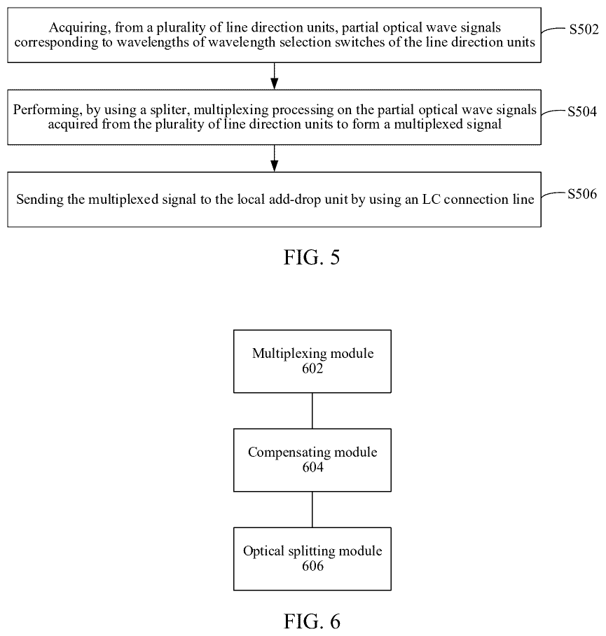

Referring to FIG. 5, a schematic flowchart of steps of a data processing method of Embodiment IV of the present application is shown.

The data processing method is applied to the reconfigurable optical add-drop multiplexer, and the method includes the following steps.

Step S502: acquiring, from a plurality of line direction units, partial optical wave signals corresponding to wavelengths of wavelength selection switches of the line direction units.

Each line direction unit receives wavelengths of an OMS multiplexed wave, the wavelength selective switch of the corresponding direction selects corresponding partial optical wave signals of one or more wavelengths and sends the partial optical wave signals to a designated port.

Step S504: performing, by using a splitter, multiplexing processing on the partial optical wave signals acquired from the plurality of line direction units to form a multiplexed signal.

The line direction units sends the partial optical wave signals to the splitter, and the splitter multiplexes the partial optical wave signals from various directions to form a multiplexed signal.

Step S506: sending the multiplexed signal to the local add-drop unit by using an LC connection line.

The splitter sends the multiplexed signal to the local add-drop unit through the LC connection line and the LC splice, the downlink power amplifier OA of the local add-drop unit compensates the multiplexed signal, and sends the compensated multiplexed signal to the multiplexer DeMux for multiplexing and sends to an electrical layer terminal for receiving.

In this way, the wavelength of the local add-drop unit can be dropped from any line direction.

### Embodiment V

Referring to FIG. 6, a structural block diagram of a data processing apparatus of Embodiment V of the present application is shown.

In this embodiment, the apparatus includes:
a multiplexing module 602, configured to perform multiplexing on optical waves to be sent by using a multiplexer to obtain an optical wave signal;
a compensating module 604, configured to perform multiplexing loss compensation processing on the optical wave signal by using an uplink power amplify to obtain a compensated optical wave signal; and
an optical splitting module 606, configured to send the compensated optical wave signal to a splitter of a fiber shuffle box through an LC connection line, so that the splitter divides the compensated optical wave signal into N uplink signals and sends the N uplink signals to corresponding line direction units in one-to-one correspondence, where a value of N is matched with the number of the line direction units.

The apparatus of this embodiment is used to realize the corresponding methods in the above-mentioned multiple method embodiments, and has the beneficial effects of the corresponding method embodiments, which will not be repeated here. In addition, the function realization of each module in the apparatus of this embodiment can refer to the description of the corresponding part in the aforementioned method embodiments, and will not be repeated here.

### Embodiment VI

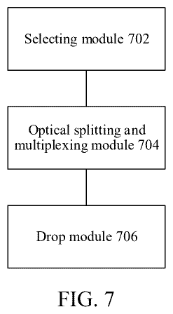

Referring to FIG. 7, a structural block diagram of a data processing apparatus of Embodiment VI of the present application is shown.

In this embodiment, the apparatus includes:
a selecting module 702, configured to acquire, from a plurality of line direction units, partial optical wave signals corresponding to wavelengths of wavelength selection switches of the line direction units;
an optical splitting and multiplexing module 704, configured to perform, by using a splitter, multiplexing processing on the partial optical wave signals acquired from the plurality of line direction units to form a multiplexed signal; and
a drop module 706, configured to send the multiplexed signal to the local add-drop unit by using an LC connection line.

The apparatus of this embodiment is used to realize the corresponding methods in the above-mentioned multiple method embodiments, and has the beneficial effects of the corresponding method embodiments, which will not be repeated here. In addition, the function realization of each module in the apparatus of this embodiment can refer to the description of the corresponding part in the aforementioned method embodiments, and will not be repeated here.

### Embodiment VII

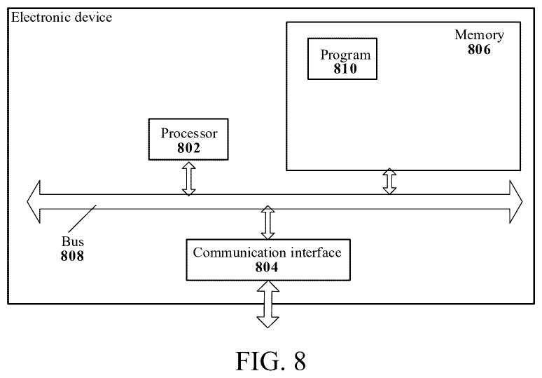

Referring to FIG. 8, a schematic structural diagram of an electronic device according to Embodiment VII of the present application is shown, and specific embodiment of the present application does not limit the specific implementation of the electronic device.

As shown in FIG. 8, the electronic device may include a processor 802, a Communications Interface 804, a memory 806, and a communication bus 808.

The processor 802, the communication interface 804 and the memory 806 communicate with each other through the communication bus 808.

The communication interface 804 is used for communicating with other electronic devices or servers.

The processor 802 is used for executing a program 810, and can specifically execute the relevant steps in the above method embodiments.

Specifically, the program 810 may include a program code, and the program code includes computer operation instructions.

The processor 802 may be a processor (central processing unit, CPU), or a specific integrated circuit ASIC (Application Specific Integrated Circuit), or one or more integrated circuits configured to implement the embodiments of the present application. One or more processors included in an intelligent device can be processors of the same type, such as one or more CPUs, or can be processors of different types, such as one or more CPUs and one or more ASICs.

The memory 806 is used for storing the program 810. The memory 806 may include a high-speed random access memory (RAM) memory, and may also include a non-volatile memory, such as at least one disk memories.

The program 810 can be specifically used to cause the processor 802 to perform operations corresponding to the aforementioned methods.

The specific implementation of each step in the program 810 could refer to the corresponding description in the corresponding steps and units in the above method embodiments, which are not repeated here. It can be clearly understood by those skilled in the art that, for the convenience and conciseness of description, the specific working processes of the devices and modules described above can refer to the corresponding process descriptions in the aforementioned method embodiments, and will not be repeated here.

An embodiment of the present application provides a computer program product, including computer instructions, where the computer instructions instruct a computing device to perform operations corresponding to any one of the above method embodiments.

It should be pointed out that, according to the requirement of implementation, each component/step described in the embodiments of the present application can be split into more components/steps, and two or more components/steps or partial operations of components/steps can be combined into new components/steps to achieve the purpose of the embodiments of the present application.

The above methods according to the embodiments of the present application could be implemented in hardware, firmware, or be implemented as a software or a computer code that can be stored in a recording medium (such as a compact disc read-only memory (CD ROM), a RAM, a floppy disk, a hard disk or a magneto-optical disk), or be implemented as a computer code that is downloaded through a network and originally stored in a remote recording medium or a non-transitory machine-readable medium and will be stored in a local recording medium, so that the method described herein can be processed by such software stored on the recording medium that uses a general-purpose computer, a dedicated processor a programmable dedicated hardware (such as a ASIC or a field programmable gate array (FPGA)). It can be understood that a computer, a processor, a microprocessor controller or a programmable hardware includes a storage component (e.g., a RAM, a ROM, and a flash memory, etc.) that can store or receive software or a computer code, and when the software or the computer code is accessed and executed by the computer, the processor or the hardware, the methods described herein are implemented. In addition, when the general-purpose computer accesses the code for implementing the methods shown here, the execution of the code converts the general-purpose computer into a special-purpose computer for executing the methods shown here.

One of ordinary skill in the art can realize that the units and method steps of the examples described with reference to the embodiments disclosed herein can be implemented in electronic hardware, or a combination of computer software and electronic hardware. Whether these functions are implemented in hardware or software depends on the specific application and design constraints of the technical solution. Professionals can use different methods to realize the described functions for each specific application, but this realization should not be considered beyond the scope of the embodiments of the present application.

The above implementations are only used to illustrate the embodiments of the present application, but not to limit the embodiments of the present application. Ordinary technicians in the relevant technical fields can make various changes and modifications without departing from the spirit and scope of the embodiments of the present application, so all equivalent technical solutions also belong to the scope of the embodiments of the present application, and a patent protection scope of the embodiments of the present application should be defined by claims.

1. A fiber shuffle box, comprising: a shuffle box main body and a splitter, wherein the splitter is built in the shuffle box main body, the shuffle box main body is provided with a first fiber connection splice for connecting with a line direction unit and a second fiber connection splice for connecting with a local add-drop unit, the splitter is connected between the first fiber connection splice and the second fiber connection splice, and the number of wire cores of the second fiber connection splice is smaller than the number of wire cores of the first fiber connection splice.

2. The method according to claim 1, wherein the first fiber connection splice uses a private transmission protocol, the second fiber connection splice uses a standard transmission protocol, and the second fiber connection splice is connected with the splitter in one-to-one correspondence.

3. A reconfigurable optical add-drop multiplexer, comprising: a line direction unit, a fiber shuffle box and a local add-drop unit, wherein the line direction unit is connected with a first fiber connection splice of the fiber shuffle box through a multi-fiber push on (MPO) connection line, the local add-drop unit is connected with a second fiber connection splice of the fiber shuffle box through a lucent connector (LC) connection line, a splitter is built in the fiber shuffle box, and the splitter is connected with the second fiber connection splice in one-to-one correspondence.

4. The reconfigurable optical add-drop multiplexer according to claim 3, wherein the line direction unit and the local add-drop unit are heterogeneous.

5. The reconfigurable optical add-drop multiplexer according to claim 3, wherein the line direction unit comprises an outgoing power amplifier, an incoming power amplifier, an outgoing wavelength selective switch and an incoming wavelength selective switch, the outgoing power amplifier is connected with the outgoing wavelength selective switch, and the incoming power amplifier is connected with the incoming wavelength selective switch.

6. The reconfigurable optical add-drop multiplexer according to claim, wherein the local add-drop unit comprises an uplink power amplifier, a downlink power amplifier, an uplink multiplexer and a downlink multiplexer, the uplink power amplifier is connected with the uplink multiplexer, and the downlink power amplifier is connected with the downlink multiplexer.

7. A data processing method, wherein the method is applied to the reconfigurable optical add-drop multiplexer according to claim 3, and the method comprises:
performing multiplexing on optical waves to be sent by using a multiplexer to obtain an optical wave signal;
performing multiplexing loss compensation processing on the optical wave signal by using an uplink power amplify to obtain a compensated optical wave signal; and
sending the compensated optical wave signal to a splitter of a fiber shuffle box through a lucent connector (LC) connection line, so that the splitter divides the compensated optical wave signal into N uplink signals and sends the N uplink signals to corresponding line direction units in one-to-one correspondence, wherein a value of N is matched with the number of the line direction units.

8. A data processing method, wherein the method is applied to the reconfigurable optical add-drop multiplexer according to claim 3, and the method comprises:
acquiring, from a plurality of line direction units, partial optical wave signals corresponding to wavelengths of wavelength selection switches of the line direction units;
performing, by using a splitter, multiplexing processing on the partial optical wave signals acquired from the plurality of line direction units to form a multiplexed signal; and
sending the multiplexed signal to the local add-drop unit by using a lucent connector (LC) connection line.

9. A non-transitory computer storage medium, having a computer program stored thereon, wherein when the computer program is executed by a processor, the method according to claim 7 is implemented.

10. (canceled)

11. The reconfigurable optical add-drop multiplexer according to claim 4, wherein the line direction unit comprises an outgoing power amplifier, an incoming power amplifier, an outgoing wavelength selective switch and an incoming wavelength selective switch, the outgoing power amplifier is connected with the outgoing wavelength selective switch, and the incoming power amplifier is connected with the incoming wavelength selective switch.

12. The reconfigurable optical add-drop multiplexer according to claim 4, wherein the local add-drop unit comprises an uplink power amplifier, a downlink power amplifier, an uplink multiplexer and a downlink multiplexer, the uplink power amplifier is connected with the uplink multiplexer, and the downlink power amplifier is connected with the downlink multiplexer.

13. A non-transitory computer storage medium, having a computer program stored thereon, wherein when the computer program is executed by a processor, the method according to claim 8 is implemented.
